(19) United States
(12) Patent Application Publication
(10) Pub. No.: US 2003/0101045 A1
(43) Pub. Date: May 29, 2003

(54) Method and apparatus for playing recordings of spoken alphanumeric characters

(76) Inventors: Peter Moffatt, Bagshot (GB); Neil Curnow, Southwood (GB)

Correspondence Address: William M. Lee, Jr., Lee, Mann, Smith, McWilliams , Sweeney & Ohlson, P.O. Box 2786, Chicago, IL, 60960-2786, US

(21) Appl. No.: 09/997,331

(22) Filed: Nov. 29, 2001

(51) Int. Cl. G06F 17/28

(52) U.S. Cl. 704/7

(57) ABSTRACT

Automated systems for “speaking” telephone numbers, zip codes and the like typically produce unrealistic results that do not sound like an actual human speaking the telephone number or zip code. By using templates together with four or more types of fragment for each alphanumeric character this problem is addressed. A fragment is a recording of a spoken alphanumeric character as spoken at a particular location within an utterance. A template is a sequence of fields, each field representing part of a sequence of alphanumeric characters. Templates comprise information about the manner in which a sequence of alphanumeric characters is to be played, such as which fragments to use and when to use pauses. Using this method alphanumeric character sequences such as telephone numbers, zip codes and the like are played with human-like intonation in real time.

### FIELD OF THE INVENTION

The present invention relates to a method and apparatus for playing recordings of spoken alphanumeric characters in sequences. The invention is particularly related to, but in no way limited to, interactive voice response (IVR) systems and other systems which aim to produce a “natural spoken” effect when playing zip codes, telephone numbers and other sequences of letters and/or digits.

### BACKGROUND TO THE INVENTION

Automated systems for “speaking” telephone numbers, zip codes and the like typically produce unrealistic results that do not sound like an actual human speaking the telephone number or zip code. For example, such systems typically use a set of sound recordings such that there is one recording for each digit. In order to produce automated “speech” for a particular zip code then the individual recordings for each digit of the zip code are played in the appropriate order. However, this produces a result which is dissimilar from that produced by a human speaking the zip code. For example, no natural pauses are left between groups of digits and the intonation is not like that of a human. As a result the sound produced is harder for a human listener to interpret or transcribe than it would have been had a human spoken the sound. This is particularly problematic for those who have not previously heard such recorded zip codes or telephone numbers and also in situations where the listener has hearing difficulties or in which the sound produced from the recording is subject to noise and distortion.

Another problem is that automated systems for “speaking” telephone numbers and the like are typically required to operate in real-time. For example, if a user telephones a directory number enquiry service and an automated system “speaks” the required number then the system is required to operate quickly in order to give the user a fast and seamless response. However, it has not previously been possible to achieve this whilst creating a realistic, human-like sound in an inexpensive manner.

A system for playing “spoken” postcodes was provided as part of lastminute.com's gift service in November 2000. This used three types of pre-recorded fragment where a fragment is a spoken letter or digit. However the ability to “speak” other types of alphanumeric character sequences such as telephone numbers and the like was not provided and the ability to use pauses at different places in the alphanumeric character sequence was unavailable. In addition, each digit of the postcode was spoken separately such that 14 was not spoken as “fourteen” and AA was not spoken “double ay”.

### OBJECT TO THE INVENTION

The invention seeks to provide an improved method and apparatus for playing recordings of alphanumeric characters in sequences which overcomes or at least mitigates one or more of the problems noted above.

Further benefits and advantages of the invention will become apparent from a consideration of the following detailed description given with reference to the accompanying drawings, which specify and show preferred embodiments of the invention.

### SUMMARY OF THE INVENTION

According to an aspect of the present invention there is provided a method of playing recordings of spoken alphanumeric characters in sequences, said method comprising the steps of:

receiving a sequence of alphanumeric characters to be played;

accessing a template comprising a sequence of fields, each field representing part of a sequence of alphanumeric characters and said template comprising information about the manner in which a sequence of alphanumeric characters is to be played;

accessing a database of fragments, each of a plurality of said fragments being a recording of a spoken alphanumeric character as spoken at a particular location within an utterance;

for each character in said received sequence of alphanumeric characters, selecting a fragment on the basis of the accessed template; and

passing said selected fragments to a player and playing the fragments.

For example, the sequence of alphanumeric characters can be a telephone number, a zip code, a credit card number or the like. By using templates in this way it is possible to obtain a more human like playing of the alphanumeric character sequence whilst at the same reducing computational complexity. The templates contain information about the manner in which the alphanumeric character sequence is to be played. For example, whether to play 100 as “one hundred” or “one zero zero” and when and where to insert pauses in the sequence. Also, the manner in which thousands, hundreds and digits pairs are to be played can be specified as well as whether “zero” or “oh” should be used or “double”, “triple” or “treble”.

Preferably the accessed template is selected from a database of templates on the basis of the received sequence of alphanumeric characters. For example, up to 500 different templates may be used making the system suitable for use with many different types and kinds of alphanumeric character sequences.

Preferably the templates in said database are prioritised. This aids in the selection process. Also, at least some of the templates in said database may contain specified alphanumeric characters in at least some of the template fields. For example, static character values can be inserted at any point in a template. This is advantageous for telephone numbers which have a fixed pre-fix for example.

In one embodiment the accessed template is selected from the database of templates by matching at least some of the received sequence of alphanumeric characters with specified alphanumeric characters in the template fields. For example, consider an 0800 telephone number. One or more templates are arranged to have fixed pre-fixes for the digits 0800 and those templates are quickly identifiable from the database by matching the input telephone number prefix against the template pre-fixes.

Preferably, said database of templates comprises sets of templates each set being suitable for use with a particular type of alphanumeric character sequence. For example, one set of templates may be suitable for telephone numbers and another set for zip codes.

In one embodiment said step of receiving a sequence of alphanumeric characters further comprises receiving values of one or more parameters. For example, one of those parameters can be used to specify a type of alphanumeric character sequence that is being input, such as a telephone number or zip code.

Preferably said database of fragments comprises at least four fragments for a plurality of said alphanumeric characters. By using four fragments it has been found that the intonation contour produced for alphanumeric character sequences is made more human-like without the need for great computational expense. In addition, it is straightforward to change the fragments in the database to those appropriate for a different language such as German, French or Japanese. This provides a simple way in which the system can be configured for operation in different countries. Alternatively, the fragments database may comprise sets of fragments for several different languages and use whichever of those is appropriate according to parameter values input with the alphanumeric character sequence.

Preferably the four fragments are a recording an alphanumeric character at each of the following positions within an utterance, where a subgroup is a part of an alphanumeric character sequence: start of a subgroup; middle of a subgroup; end of a subgroup; and end of an utterance. Using these types of fragment has been found to produce particularly good results for alphanumeric character sequences.

In one embodiment the system is arranged to provide autorecovery. If the said selected template is incompatible with the input alphanumeric data sequence, then the template is adapted to be compatible with the received alphanumeric data sequence. For example, the number of fields in the template may be increased or the position of pauses within the template adjusted.

Advantageously, the alphanumeric character sequence is received, the method completed and the sequence played in real time. For example, processing time for a typical telephone number has been found to be less than 0.02 seconds as described below.

According to another aspect of the present invention there is provided an apparatus for playing recordings of spoken alphanumeric characters in sequences, said apparatus comprising:

an input arranged to receive a sequence of alphanumeric characters to be played;

a processor arranged to access a template comprising a sequence of fields, each field representing part of a sequence of alphanumeric characters and said template comprising information about the manner in which a sequence of alphanumeric characters is to be played;

said processor being further arranged to access information about fragments, each of a plurality of said fragments being a recording of a spoken alphanumeric character as spoken at a particular location within an utterance;

said processor being further arranged, for each character in said received sequence of alphanumeric characters, to select a fragment on the basis of the accessed template; and

an output arranged to pass information about said selected fragments to a player which is arranged to play the fragments.

For example, the player is preferably provided by an interactive voice response (IVR) system and it is also possible for the processor itself to be integral with the IVR system. Thus the apparatus is preferably connected within a communications network.

According to another aspect of the present invention there is provided a computer program arranged to control a processor and player in order to play recordings of spoken alphanumeric characters in sequences, said computer program being arranged to control said process and player such that:

a sequence of alphanumeric characters to be played is received;

a template is accessed comprising a sequence of fields, each field representing part of a sequence of alphanumeric characters and said template comprising information about the manner in which a sequence of alphanumeric characters is to be played;

a database of fragments is accessed, each of a plurality of said fragments being a recording of a spoken alphanumeric character as spoken at a particular location within an utterance;

a fragment is selected for each character in said received sequence of alphanumeric characters, said fragment being selected on the basis of the accessed template; and

said selected fragments are passed to the player which plays the fragments.

Preferably the computer program is stored on a computer readable medium. Any suitable computer programming language may be used as is described in more detail below.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 is a schematic diagram of a system for playing recordings of spoken digits and/or letters;

FIG. 2 is a flow diagram of a method for playing recordings of spoken digits and/or letters;

FIG. 3 is a schematic diagram of a communications network comprising the system of FIG. 1.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

The term “alphanumeric character sequence” is used herein to refer to a list of digits and/or letters. Zip codes, telephone numbers and credit or debit card numbers are all examples of types of alphanumeric character sequences.

The term “fragment” is used herein to refer to a recording of a spoken letter or digit where that letter or digit is at a particular location within a spoken alphanumeric character sequence. A fragment may also be a recording of a spoken word, phrase, syllable or pause.

The term “template” is used herein to refer to a sequence of fields where each field represents a letter, digit or other part of an alphanumeric character sequence and wherein the template is used to hold information about the manner in which an alphanumeric character sequence is to be played.

The term “utterance” is used herein to refer to a stretch of speech in some way isolated from, or independent of, what precedes and follows it.

The term “intonation” is used herein to refer to modulation or rise and fall in pitch of the voice.

As described above, known systems for automatically speaking alphanumeric character sequences are problematic because the results do not sound like a human speaker. The present invention recognises that there are many reasons for this. For example, the sound produced by a human speaker speaking a letter or digit varies depending on the position of that letter or digit in relation to other sounds spoken by the speaker. For example, at the end of an utterance there is often a falling intonation.

Previous systems have sought to address this problem by using separate recordings for particular letters and digits at each different position within an utterance. However, this is problematic because the number of individual recordings required quickly becomes very large and this increases computational expense and recording costs.

The present invention also recognises that human speakers often leave pauses between groups and subgroups of letters and/or digits within alphanumeric character sequences. For example, when speaking a telephone number, a pause is often left between the country code, area code and the rest of the telephone number. Pauses may also be left between pairs of digits within the telephone number itself or between groups of three digits for example. In addition, human speakers may pronounce a particular digit or letter in different ways. For example, the digit 0 may be pronounced “zero”, or “oh”. However, use of such pauses and different pronunciations varies depending on the type of alphanumeric character sequence being spoken, the particular alphanumeric character sequence involved, and the speaker's individual characteristics. Thus, it is a complex task to take all these factors into account and produce a realistic, natural sounding, “spoken” alphanumeric character sequence, whilst constraining computational complexity and allowing real-time applications to be produced.

The present invention uses templates in order to address this problem together with four or more different types of fragment. Templates have not previously been used in the types of system described herein. For example, the British Telecommunications system mentioned above did not use templates.

As mentioned above, a “template” is a sequence of fields where each field represents a letter, digit or other part of an alphanumeric character sequence and wherein the template is used to hold information about the manner in which an alphanumeric character sequence is to be played. For example, whether any pauses should be inserted at particular locations in the alphanumeric character sequence and which particular types of fragment should be used.

In a preferred embodiment four types of fragment are used although it is possible to use more than four types. As described above, a “fragment” is used herein to refer to a recording of a spoken letter or digit where that letter or digit is at a particular location within a spoken alphanumeric character sequence. A fragment may also be a recording of a spoken word, phrase, syllable or pause. Thus in the preferred embodiment, each particular letter or digit is recorded four times to create four fragments. Each fragment corresponds to the letter or digit as spoken at a different location within an utterance. These four different locations are listed below where a group is a plurality of sequential letters and or digits within an alphanumeric character sequence which are separated from the rest of the alphanumeric character sequence by a pause. Similarly, a subgroup is a plurality of sequential letters and or digits within an alphanumeric character sequence which are separated from the rest of the alphanumeric character sequence by a pause which is shorter than that for a group.

Start-of-subgroup

Middle-of-subgroup

End-of-subgroup

End-of-utterance

For each of these different types of fragment the intonation is different. Thus in a preferred embodiment, fragments of type start-of-subgroup have a rising intonation, fragments of type middle-of-subgroup have a level intonation, fragments of type end-of-subgroup have a variable (falling-rising) intonation and fragments of type end-of-utterance have a falling intonation.

An example of a template is given below where some of the initial fields of the template are instantiated with particular fragments.

020!7ddd dddd

In this example, the symbol “!” is used to indicate a pause between a group and the rest of the template and the symbol “d” is used to represent a field that can hold a digit as opposed to a letter. This template is used for London telephone numbers which begin with the area code 020 and a local area code beginning with 7. The local area code in this example has space for four digits. A pause indicated by a space is then present followed by a four digit telephone number.

An example of a default template which has no pre-specified characters is given below:

dddd!ddd ddd

Here the template has four digit fields, a group pause, three digit fields, a subgroup pause and three further digit fields.

Other symbols within the template can be used to represent the fact that the digits should not be spoken as individual digits if possible. For example the template below:

0[800]!ddd dddd

indicates that the alphanumeric character sequence should be played as “oh, eight hundred, pause” followed by three digits read in sequence, a subgroup pause and four further digits.

In this way information is provided in the templates about the manner in which the alphanumeric character sequences should be played.

In a preferred embodiment, for each letter and digit, four fragments are recorded and stored in a fragment database. These fragments are preferably stored in the database by separating them into sets, for example, one set for digits and one set for letters. Fragments for phrases such as “country code” and words such as “and”, “double” and “triple” as well as pauses of different lengths are also preferably stored in the database. Fragments comprising recordings of spoken numbers such as ten, one thousand, nine hundred and phrases such as “double zero” may also be stored in the database. As before, different fragment types for each of these is recorded and stored depending on the position of the phrase, word or number in an utterance. Thus in a preferred example, about 300 fragments are used.

As explained above, a template is a sequence of fields where each field represents a letter, digit or other part of an alphanumeric character sequence and wherein the template is used to hold information about the manner in which an alphanumeric character sequence is to be played. Thus particular templates may have pauses of specified lengths to divide an alphanumeric character sequence into groups and subgroups. A particular template also specifies which type of fragment to use in a particular field. Also, a template may have a one or more of its fields filled with specified fragments.

A plurality of templates are created and stored in a template database. Preferably, the templates are ordered in some manner, for example by being stored in lists where the higher an item in the list, the higher its priority. In the case that the system is used to automatically “speak” two or more different types of alphanumeric character sequence (e.g. zip codes and telephone numbers) then the templates are preferably stored in groups, one for each type of alphanumeric character sequence. Within each of those groups the templates are preferably prioritised.

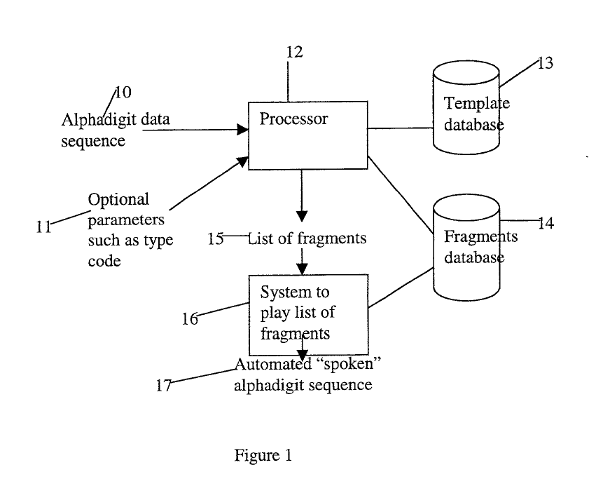

FIG. 1 is a schematic diagram of a system for automatically “speaking” alphanumeric character sequences according to an embodiment of the present invention. It comprises a processor 12 which is connected to a template database 13 and a fragments database 14. The processor has inputs which are arranged to receive an alphanumeric character sequence 10 and optional parameters 11 such as a type code. (Where a type code is used to indicate which type of alphanumeric character sequence is being input.) The processor is also connected to a system 16 for playing lists of fragments to create an automated “spoken” version 17 of the alphanumeric character sequence. This system 16 may be any suitable system for playing fragments as is known in the art. Preferably, the processor 12 is arranged to output a list of fragments for use in the “spoken” version of the alphanumeric character sequence and this output is passed to the system 16 for playing the fragments.

In another embodiment the fragments database 14 is connected to the system for playing 16 instead of, or in addition to, being connected to the processor 12. In that case, the processor is used to assemble fragment names which are effectively keys into the database of fragments. Thus the processor, instead of producing a list of fragments, produces a list of fragment names. In order to do this the processor uses information about the available fragments. The list of fragment names is passed to the system for playing 16 which then accesses the fragments database, obtains the fragments required on the basis of the fragment names, and plays those fragments.

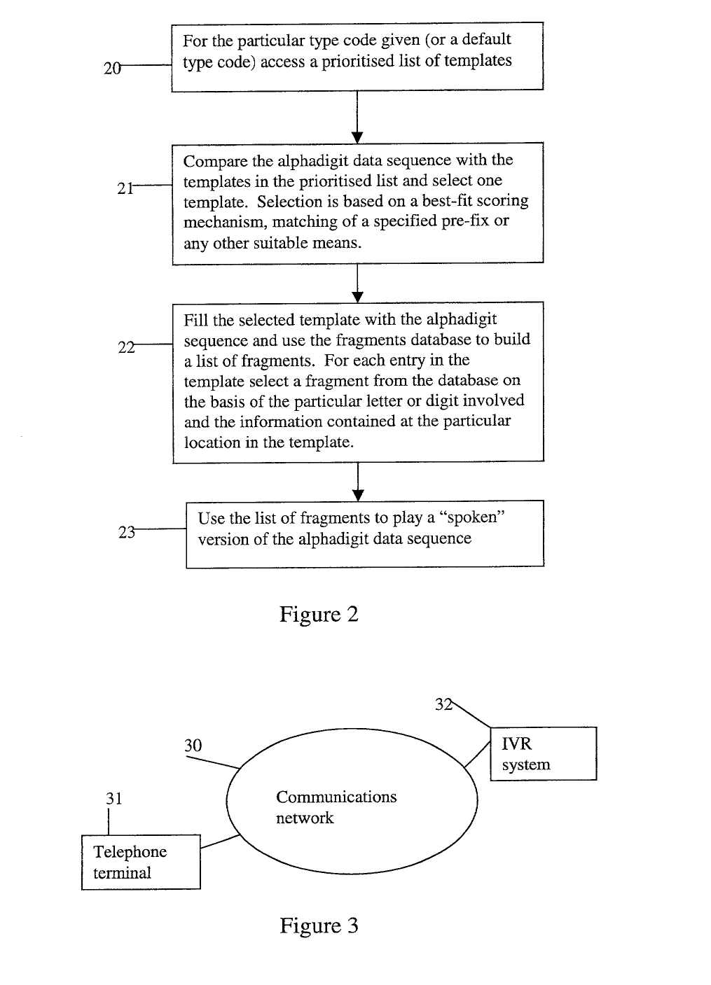

FIG. 2 is a flow diagram of a method of creating an automated “spoken” alphanumeric character sequence using the system of FIG. 1. The processor 12 first receives an input alphanumeric character sequence to be spoken together with optional parameters 11 such as a type code.

Together with the alphanumeric character sequence, any available information associated with that sequence is input, such as any group or subgroup information for the alphanumeric character sequence.

The processor then accesses the template database 13 in order to select an appropriate template to use. For example, if a type code was input to the processor 12, the type code is used to select a group of templates for that type code (see box 20 of FIG. 2). In a preferred embodiment, the templates within each group are prioritised, although this is not essential. One of the templates is then selected on the basis of the input alphanumeric character sequence (see box 21 of FIG. 2). This selection process is achieved in any suitable manner. In a preferred embodiment, a best-fit scoring mechanism is used. In this method, the alphanumeric character sequence is compared with each template in the group for a plurality of criteria. For example, the length of the template in terms of number of fragments, the pattern of groups and subgroups in the template and the order of digits and letters in the sequence. Depending on how closely the input alphanumeric character sequence matches each template for these criteria, scores are allocated and summed. The template for which the highest score is found, and which has the highest priority, is then selected. In another example, the initial digits or letters of the alphanumeric character sequence are matched against those in the templates (for those templates that have filled initial fields) and the template with the closest match and highest priority selected. Combinations of these selection methods or other suitable selection methods can also be used.

The selected template is then combined with the alphanumeric character sequence. Fragments are accessed from the fragment database in order to create a fragment list. These fragments are selected on the basis of the information in the selected template and the alphanumeric character sequence (see box 22 of FIG. 2). For example, the first item in the alphanumeric character sequence may be 0 and the first field in the template may indicate that a fragment for “oh” is to be used. The next items in the alphanumeric character sequence may be 800 and the template fields indicate that the next fragment should be for “eight hundred” followed by a pause fragment. In this manner a fragment list is built up and output from the processor 12 to a system 16 for playing the “spoken” alphanumeric character sequence (see box 23 of FIG. 2).

The system of FIG. 1 is preferably incorporated into a communications network 30 as shown in FIG. 3. The system for playing the fragment list is an IVR system 32 or any other suitable playing device. The processor 12 may be incorporated into the IVR system 32 or may be separate and connected within the communications network 30. For example, consider a user of a telephone terminal 31 (or any other suitable type of terminal) who makes a call to a directory number providing service. That service is provided at a node in the communications network which obtains the required directory number and passes it as an alphanumeric character sequence to the processor 12 together with any optional parameters (see below). The processor 12 then produces a fragment list which is passed to the IVR system 32 which plays the fragment list to the user of the terminal 31.

Optional parameters

As mentioned above, optional parameters 11 can be input to the processor 12 along with the alphanumeric character sequence 10. These include a type code as mentioned above and for example, other parameters as listed below: Pre-formatted data—this parameter has a value of true or false. If true the processor does not attempt to select a template as in box 21 of FIG. 2. Instead the processor uses the formatting embedded in the alphanumeric character sequence 10 itself. This provides the advantage that the fragment list is built directly from the alphanumeric character sequence and the fragment database without the need for templates. Thus by using this parameter the system can be used for alphanumeric character sequences for which intonation and pause information is already known as well as for alphanumeric character sequences where this is not the case.

Override template—this parameter is used to specify a particular template that is to be used. That is, the process of template selection in box 21 of FIG. 2 is simplified because the template specified in the override template is used. This provides the advantage that in situations where it is known that the alphanumeric character sequence is for example, an 0800 telephone number with a further 7 digits then the appropriate template can be specified.

Silent—this parameter is used to prevent the processor from outputting the fragment list 15 to the system 16 for playing that fragment list.

Prompt list—this parameter is used to eventually carry the fragment list 15 produced by the processor. It can also be used to hold fragments that will be prefixed to the output. For example, if the output will always be an international telephone number then a fragment for “country code” can be prefixed to the output.

Auto recovery

In some situations, the alphanumeric character sequence 10 input to the processor does not match any of the available templates. For example, the alphanumeric character sequence may be shorter than any of the available templates because of an error. In such cases, the process of box 21 of FIG. 2 fails because no suitable template is selected and an error is returned. Embodiments of the invention in which this is possible are referred to as running in validation mode. However, a preferred example of the present invention is arranged to deal with this situation using an auto recovery mechanism. In this case, the closest template is adapted to fit the input alphanumeric character sequence. For example, if the closest template has a group which is shorter than the group specified in the alphanumeric character sequence then the extraneous characters are shifted forwards into the next group of the template. Alternatively, if the alphanumeric character sequence has a group which is shorter than the group in the template then some characters from the next group in the template are moved back into the unfilled group.

Some examples of alphanumeric character sequences that may be input to the processor 12 are given below, together with a description of the alphanumeric character sequences and the spoken output obtained (intonation is not shown).

| Description | Data | Spoken output |
|---|---|---|
| Local phone | 690742 | six nine zero, seven four two |
| number | | |
| National | 012766925 | oh one two seven six; six nine |
| phone number | 38 | two, five three eight |
| National | 080000004 | oh eight-hundred; treble-oh, |
| phone number | 42 | double-four two |
| with specific | | |
| formatted | | |
| template | | |
| International | 309745000 | country-code thirty; nine seven |
| phone number | 000 | four; five-thousand treble-oh |
| Credit card | 123456789 | one two three four; five six |
| number | 0123456 | seven eight; nine zero one two; |
| | | three four five six |
| UK zip code | GU167QN | G U sixteen; seven Q N |

Note:
The use of pauses, natural numbers, multiples and zero/oh is configurable.

In a preferred example, the processor 12 is provided on an UltraSPARC AXi360 as currently commercially available from Sun Microsystems. In that case, using the methods described above, the pre-processing time for a typical telephone number is less than about 0.02 seconds. However, as mentioned above, any suitable type of processor may be used.

Any range or device value given herein may be extended or altered without losing the effect sought, as will be apparent to the skilled person for an understanding of the teachings herein.

1. A method of playing recordings of spoken alphanumeric characters in sequences, said method comprising the steps of:
(i) receiving a sequence of alphanumeric characters to be played;
(ii) accessing a template comprising a sequence of fields, each field representing part of a sequence of alphanumeric characters and said template comprising information about the manner in which a sequence of alphanumeric characters is to be played;
(iii) accessing a database of fragments, each of a plurality of said fragments being a recording of a spoken alphanumeric character as spoken at a particular location within an utterance;
(iv) for each character in said received sequence of alphanumeric characters, selecting a fragment on the basis of the accessed template; and
(v) passing said selected fragments to a player and playing the fragments.

2. A method as claimed in claim 1 wherein said accessed template is selected from a database of templates on the basis of the received sequence of alphanumeric characters.

3. A method as claimed in claim 2 wherein the templates in said database are prioritised.

4. A method as claimed in claim 2 wherein at least some of the templates in said database contain specified alphanumeric characters in at least some of the template fields.

5. A method as claimed in claim 4 wherein said accessed template is selected from the database of templates by matching at least some of the received sequence of alphanumeric characters with specified alphanumeric characters in the template fields.

6. A method as claimed in claim 3 wherein said accessed template is selected from the database of templates on the basis of the priority of the templates as well as on the basis of the received sequence of alphanumeric characters.

7. A method as claimed in claim 2 wherein said database of templates comprises sets of templates each set being suitable for use with a particular type of alphanumeric character sequence.

8. A method as claimed in claim 1 wherein said template information about the manner in which a sequence of alphanumeric characters is to be played comprises information about pauses.

9. A method as claimed in claim 1 wherein said step (i) of receiving a sequence of alphanumeric characters further comprises receiving values of one or more parameters.

10. A method as claimed in claim 8 wherein one of said parameters specifies a type of alphanumeric character sequence.

11. A method as claimed in claim 1 wherein said alphanumeric character sequence is selected from: a telephone, directory or subscriber number; a credit card or debit card number; a zip code or post code; an area or country code; a telex number; an account, membership, staff, customer, supplier or user number; a social security or national insurance number; a personal identification number (PIN), security number or pass code; a call or message identifier; a date or time; an age or duration; a length or volume; a monetary amount; a sort code; a tax code or rate; an interest rate; an exchange rate; a company registration number; a meter reading; a serial number; an inventory number; a policy or contract number; a loyalty scheme point quantity; a stock control identifier (skulD), part number or product code; a stock quantity, weight or measure; an order, booking, tracking, receipt, invoice or job number; a vehicle registration mark; a road number; a map or grid reference; a building, flat, floor or room number; a post office box number or internal mailstop code; a flight number; a stock ticker symbol; a telephone keypad sequence; a version string; an email address; an international standard book number (ISBN); an international standard serial number (ISSN); a globally unique identifier (GUID); a digital object identifier (DOI); a formal public identifier (FPI); an internet protocol (IP) address; and a universal resource identifier (URI).

12. A method as claimed in claim 1 wherein said database of fragments comprises at least four fragments for a plurality of said alphanumeric characters.

13. A method as claimed in claim 11 wherein said four fragments are a recording an alphanumeric character at each of the following positions within an utterance, where a subgroup is a part of an alphanumeric character sequence: start of a subgroup; middle of a subgroup; end of a subgroup; and end of an utterance.

14. A method as claimed in claim 2 wherein if said selected template is incompatible with said received alphanumeric data sequence, then said template is adapted to be compatible with the received alphanumeric data sequence.

15. A method as claimed in claim 1 whereby the alphanumeric character sequence is received, the method of claim 1 completed and the sequence played in real time.

16. An apparatus for playing recordings of spoken alphanumeric characters in sequences, said apparatus comprising:
(i) an input arranged to receive a sequence of alphanumeric characters to be played;
(ii) a processor arranged to access a template comprising a sequence of fields, each field representing part of a sequence of alphanumeric characters and said template comprising information about the manner in which a sequence of alphanumeric characters is to be played;
(iii) said processor being further arranged to access information about fragments, each of a plurality of said fragments being a recording of a spoken alphanumeric character as spoken at a particular location within an utterance;
(iv) said processor being further arranged, for each character in said received sequence of alphanumeric characters, to select a fragment on the basis of the accessed template; and
(v) an output arranged to pass information about said selected fragments to a player which is arranged to play the fragments.

17. An apparatus as claimed in claim 16 wherein said player is arranged to access the selected fragments from a database of fragments.

18. An apparatus as claimed in claim 16 wherein said player is provided by an interactive voice response (IVR) system.

19. An apparatus as claimed in claim 16 wherein said processor is integral with an interactive voice response (IVR) system.

20. A communications network comprising an apparatus as claimed in claim 16.

21. A computer program arranged to control a processor and player in order to play recordings of spoken alphanumeric characters in sequences, said computer program being arranged to control said process and player such that:
(i) a sequence of alphanumeric characters to be played is received;
(ii) a template is accessed comprising a sequence of fields, each field representing part of a sequence of alphanumeric characters and said template comprising information about the manner in which a sequence of alphanumeric characters is to be played;
(iii) a database of fragments is accessed, each of a plurality of said fragments being a recording of a spoken alphanumeric character as spoken at a particular location within an utterance;
(iv) a fragment is selected for each character in said received sequence of alphanumeric characters, said fragment being selected on the basis of the accessed template; and
(v) said selected fragments are passed to the player which plays the fragments.

22. A computer program as claimed in claim 20 which is stored on a computer readable medium.

23. An automated directory number enquiry system comprising an apparatus as claimed in claim 16.
